(19) United States
(12) Patent Application Publication
(10) Pub. No.: US 2018/0326508 A1
(43) Pub. Date: Nov. 15, 2018

(54) SCREWING TOOL PROVIDED WITH HIGH-TORSION HANDLE

(71) Applicant: JALOR INDUSTRY CO., LTD., JIANGSU (CN)

(72) Inventors: Ning JIANG, JIANGSU (CN); Juhua ZHU, JIANGSU (CN)

(73) Assignee: JALOR INDUSTRY CO., LTD., JIANGSU (CN)

(21) Appl. No.: 15/668,690

(22) Filed: Aug. 3, 2017

(30) Foreign Application Priority Data
May 15, 2017 (CN) 201710339999.6

(51) Int. Cl. B23B 51/02; B25B 23/00; B23K 26/386; B23K 26/384; B23K 26/146; B23K 26/03

(52) U.S. Cl. CPC B23B 51/02; B25B 23/0007; B23K 26/386; B25B 21/00; B23K 26/146; B23K 26/032; B23K 26/384

(57) ABSTRACT

A screwing tool provided with a high-torsion handle including a screwing tool body and a screwing tool handle is provided. An inner hole in an irregular shape is formed in the screwing tool handle, and the shape of the top end of the screwing tool body is the same as that of the inner hole. The screwing tool body and the screwing tool handle are fixed to each other via high-strength glue, and the inner hole of the screwing tool handle is a semi-cylindrical inner hole, a triangular inner hole, a quadrilateral inner hole, a hexagonal inner hole, an octagonal inner hole or a decagonal inner hole. Since the inner hole of the handle is machined into the irregular polygon, all types of screwing tools including drill bits can be fixed to the screwing tool handle via the high-strength glue.

### CROSS-REFERENCE TO RELATED APPLICATION

This application claims the priority benefit of China application serial no. 201710339999.6, filed on May 15, 2017. The entirety of the above-mentioned patent application is hereby incorporated by reference herein and made a part of this specification.

### BACKGROUND OF THE INVENTION

### Technical Field

The invention relates to a screwing tool, in particular, to a screwing tool provided with a high-torsion handle.

### Description of Related Art

Handles for screwing tools such as drill bits, screwdrivers or sleeves are generally hexagonal handles, SDS handles, triangular handles, square handles, octagonal handles or round handles, and the inner holes of the handles are all round holes. Taking a drill bit as an example, the drill bit and a handle are connected mainly through an integral process, a stamping process and a pin process; the integral process refers to the drill bit and the handle being integrated; the stamping process refers to a plane being machined on the drill bit and then the plane is stamped to be fixed; the pin process refers to the drill bit and the hexagonal handle being punched to be fixed through a steel column penetrating through the drill bit and the hexagonal handle; due to the fact that holes of handles can only be machined through a traditional drill bit machining method currently, the machined holes are definitely round, torsion of products is not qualified, radial run-out is extremely large, the handles cannot be rigid and have appearance defects, the products are prone to breakage, and the life-cycle cannot meet the expectations customers during drilling.

### BRIEF SUMMARY OF THE INVENTION

For solving the above problems, the invention provides a screwing tool provided with a high-torsion handle, an inner hole of the screwing tool is an irregular polygon, all types of drill bits can be fixed to the handle, rapid switching between a screwing tool body and the handle can be achieved, and strength is high.

The technical scheme adopted by the invention for achieving the above purpose is as follows:

The invention provides a screwing tool provided with a high-torsion handle, and the screwing tool provided with a high-torsion handle includes a screwing tool body and a screwing tool handle, and is characterized in that an inner hole in an irregular shape is formed inside the screwing tool handle, the shape of the top end of the screwing tool body is the same shape as that of the inner hole, and the screwing tool body and the screwing tool handle are fixed to each other via glue.

The screwing tool provided with a high-torsion handle of the invention is further improved in that the inner hole of the screwing tool handle is a blind hole, and the blind hole is machined through the following steps:

(1) the hole is formed, the optimal angle between a workpiece and the ground is 90 degrees, the wavelength of an adopted laser machine is 1070-1080 nm, the degree of spatial freedom is six axes, the positioning precision is +/−0.1 mm, the minimum line width is 0.1 mm, infrared light is used for aiming and positioning, a water cooling method is adopted, and the power of the laser machine is 5000 W; the blind hole with the diameter being 1.0 mm is formed in the workpiece through high-power CO laser light first, the depth of the blind hole is measured through an infrared sensor, and the infrared sensor and the laser machine are both connected with a controller; after the laser drilling depth reaches the depth preset by the controller, infrared light transmits a measured signal to the controller in time, the controller controls the laser machine to stop laser work, and the measurement precision reaches 0.1 mm;

(2) the blind hole in step (1) is burn-melted through a high-power laser machine, so that the dimensional precision of the blind hole reaches negative 0.2-0.3 mm, and the laser power reaches 3500 W;

(3) the hole shape is accurately machined through a laser device with the power being 2500 W, and the final machining precision is positive 0.1-0.15 MM.

The screwing tool provided with a high-torsion handle of the invention is further improved in that the blind hole is a semi-cylindrical inner hole, a triangular inner hole, a quadrilateral inner hole, a hexagonal inner hole, an octagonal inner hole, or a decagonal inner hole.

The screwing tool provided with a high-torsion handle of the invention is further improved in that the screwing tool is a drill bit, a screwdriver or a sleeve.

The screwing tool provided with a high-torsion handle of the invention is further improved in that a gap between the screwing tool body and the screwing tool handle is between 0.1 mm and 0.2 mm.

The invention has the beneficial effects that the inner hole of the handle is machined into an irregular polygon and cut through high-energy laser light so that all types of screwing tools including drill bits can be fixed to the handle and then fixed through high-strength glue, and thus the technical problem of connecting handles of screwing tools for nearly 30 years is solved fundamentally; the effect of the high-torsion handle is basically consistent with the effect of integral handles, the machining problem of the integral handles is solved, the production cost of products is greatly reduced, and the application range of the products can be widened; existing screwing tools can be used for electric tools with the impacting function, high-power electric tools and the like, drill bits can be switched rapidly, time is saved, working efficiency is improved, the service life of existing products is prolonged, the production cost of the products is greatly reduced, production efficiency is greatly improved, and production is simplified.

The invention is simple in structure and reasonable and novel in design, the handle is high in strength, and requirements for handles in various shapes can be met.

### BRIEF DESCRIPTION OF THE SEVERAL VIEWS OF THE DRAWINGS

FIG. 1 is a structure schematic diagram of the invention.

FIG. 2 is a sectional view of a drill bit body according to a first embodiment of the invention.

FIG. 3 is a sectional view of an inner hole of a handle according to the first embodiment of the invention.

FIG. 4 is a sectional view of a drill bit body according to a second embodiment of the invention.

FIG. 5 is a sectional view of an inner hole of a handle according to the second embodiment of the invention.

FIG. 6 is a sectional view of a drill bit body according to a third embodiment of the invention.

FIG. 7 is a sectional view of an inner hole of a handle according to the third embodiment of the invention.

FIG. 8 is a sectional view of a drill bit body according to a fourth embodiment of the invention.

FIG. 9 is a sectional view of an inner hole of a handle according to the fourth embodiment of the invention.

FIG. 10 is a sectional view of a drill bit body in a fifth embodiment according to the invention.

FIG. 11 is a sectional view of an inner hole of a handle according to the fifth embodiment of the invention.

FIG. 12 is a sectional view of a drill bit body according to a sixth embodiment of the invention.

FIG. 13 is a sectional view of an inner hole of a handle according to the sixth embodiment of the invention.

FIG. 14 is a sectional view of a drill bit body according to a seventh embodiment of the invention.

FIG. 15 is a sectional view of an inner hole of a handle according to the seventh embodiment of the invention.

FIG. 16 is a schematic diagram of radial run-out comparison of the invention.

FIG. 17 is a schematic diagram of radial run-out deviation of the invention.

FIG. 18 is a schematic diagram of torsion comparison of the invention.

FIG. 19 is a schematic diagram of torsion deviation of the invention.

### DETAILED DESCRIPTION OF THE INVENTION

For a deeper understanding of the invention, a further detailed description of the invention is given with the accompanying drawings and embodiments as follows, and the embodiments are only used for explaining the invention, but not limit the protection scope of the invention.

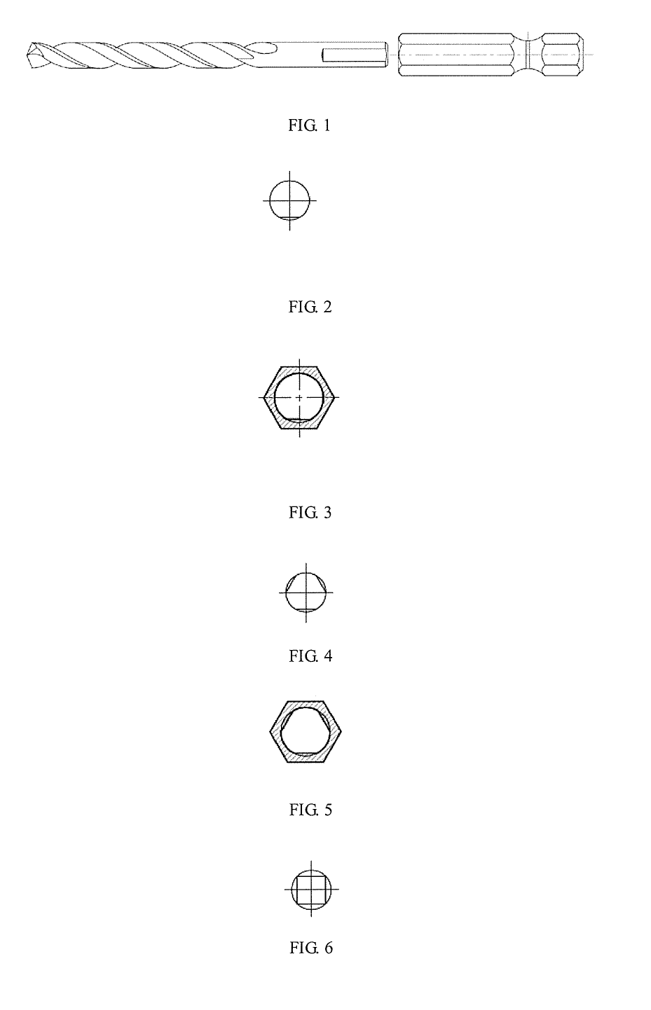

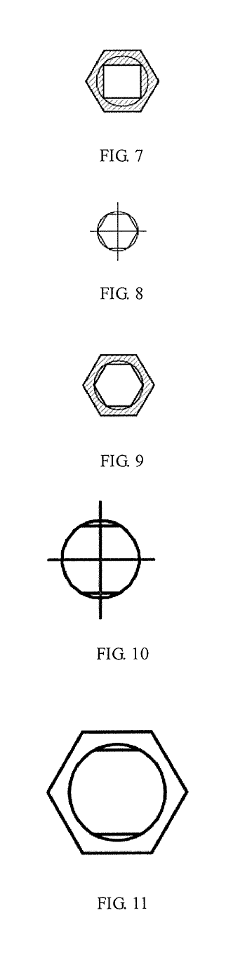

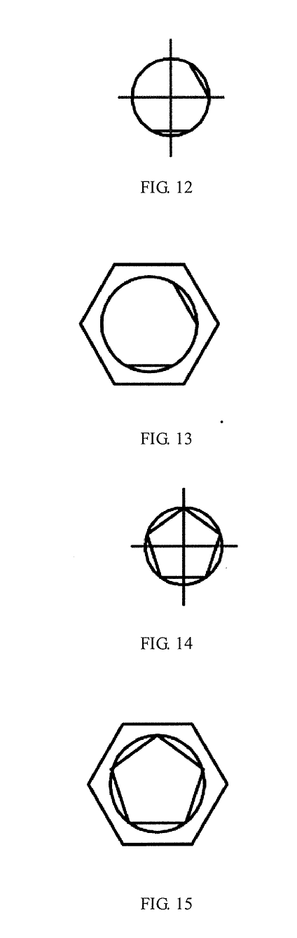

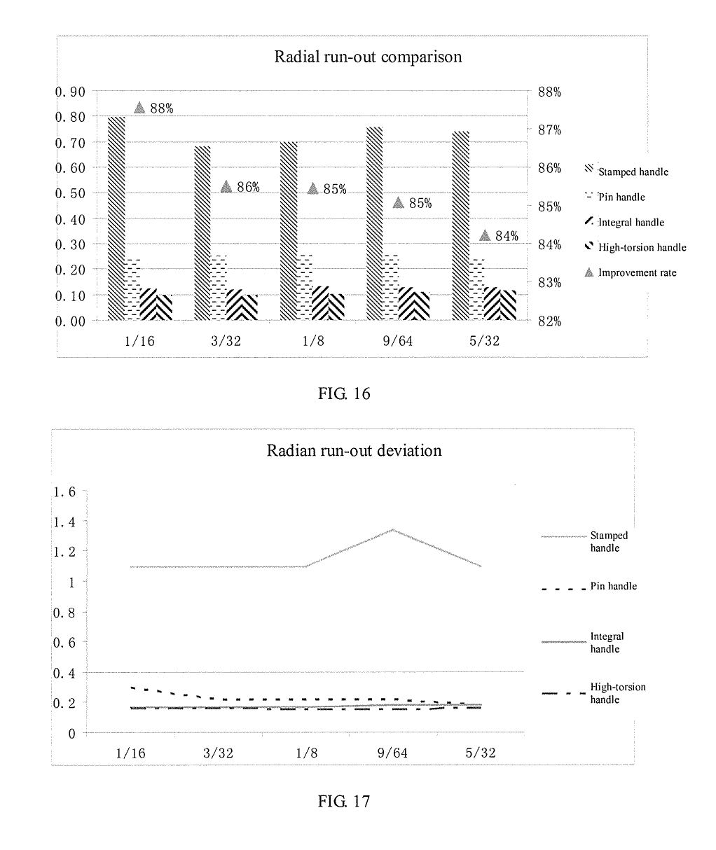

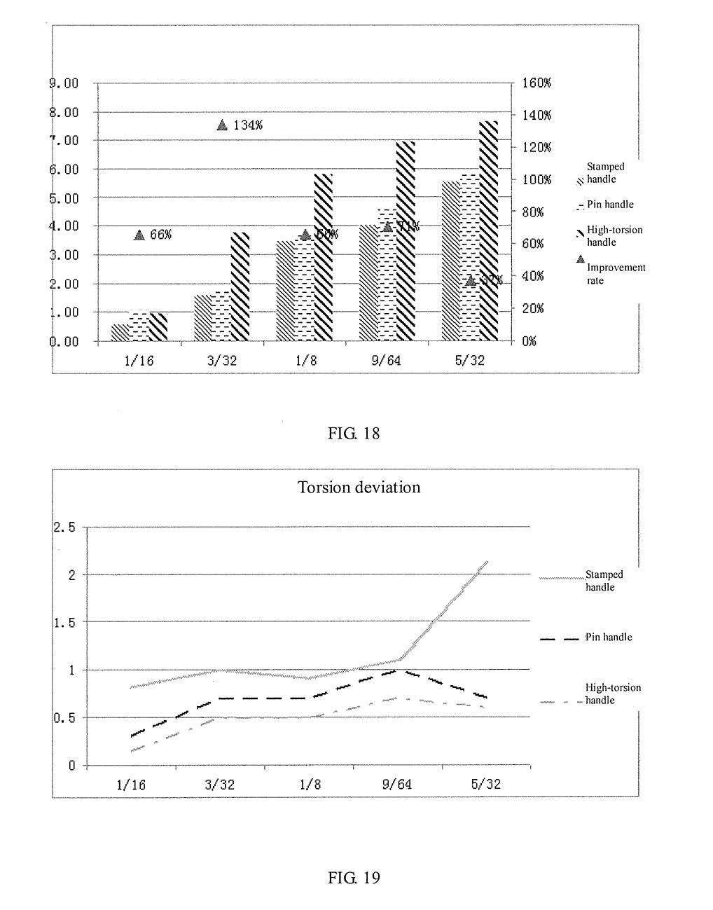

As shown in FIGS. 1-19, the invention provides a screwing tool provided with a high-torsion handle. The screwing tool provided with a high-torsion handle includes a screwing tool body and the screwing tool handle, wherein an inner hole in an irregular shape is formed inside the screwing tool handle, the shape of the top end of the screwing tool body is the same as that of the inner hole, and the screwing tool body and the screwing tool handle are fixed to each other via glue.

The inner hole of the screwing tool handle is a blind hole, and the blind hole is machined through the following steps:

(1) the hole is formed, the optimal angle between a workpiece and the ground is 90 degrees, the wavelength of an adopted laser machine is 1070-1080 nm, the degree of spatial freedom is six axes, the positioning precision is +/−0.1 mm, the minimum line width is 0.1 mm, infrared light is used for aiming and positioning, a water cooling method is adopted, and the power of the laser machine is 5000 W; the blind hole with the diameter being 1.0 mm is formed in the workpiece through high-power CO laser light first, the depth of the blind hole is measured through an infrared sensor, and the infrared sensor and the laser machine are both connected with a controller; after the laser drilling depth reaches the depth preset by the controller, infrared light transmits a measured signal to the controller in time, the controller controls the laser machine to stop laser work, the measurement precision reaches 0.1 mm, and the optimal angle between the workpiece and the ground is 90 degrees when the workpiece is machined.

(2) the blind hole in step (1) is burn-melted through a high-power laser machine, so that the dimensional precision of the blind hole reaches negative 0.2-0.3 mm, the laser power reaches 3500 W, and the interior of the hole is burn-melted; since a guide groove is formed through laser light in step (1) and the workpiece is perpendicular to the ground, molten metal can flow out directly after burn-melting;

(3) the hole shape is accurately machined through a laser device with the power being 2500 W, the final machining precision is positive 0.1-0.15 MM, and since the basic dimension of the hole burn-melted in step (2) has already reached negative 0.2-0.3 MM, only medium-power laser light is needed for machining the inner hole.

The blind hole is a semi-cylindrical inner hole, a triangular inner hole, a quadrilateral inner hole, a hexagonal inner hole, an octagonal inner hole, or a decagonal inner hole, the screwing tool is a drill bit or a sleeve, a gap between the screwing tool body and the screwing tool handle is between 0.1 mm and 0.2 mm, and the space between the screwing tool body and the screwing tool handle can be filled with glue conveniently.

### First Embodiment

A drill bit provided with a high-torsion handle of the invention includes a drill bit body and the drill bit handle. An inner hole in an irregular shape is formed inside the drill bit handle, the shape of the top end of the drill bit body is the same as that of the inner hole, and the drill bit body and the drill bit handle are fixed to each other via high-strength glue. During mounting, the glue is smeared on the drill bit body or in the inner hole of the drill bit handle, the inner hole of the drill bit handle is a semi-cylindrical inner hole, and the top end of the drill bit body is a single-side polished handle.

### Second Embodiment

A drill bit provided with a high-torsion handle of the invention includes a drill bit body and the drill bit handle. An inner hole in an irregular shape is formed inside the drill bit handle, the shape of the top end of the drill bit body is the same as that of the inner hole, and the drill bit body and the drill bit handle are fixed to each other via high-strength glue. During mounting, the glue is smeared on the drill bit body or in the inner hole of the drill bit handle, the inner hole of the drill bit handle is a triangular inner hole, and the top end of the drill bit body is a three-side polished handle.

### Third Embodiment

A drill bit provided with a high-torsion handle of the invention includes a drill bit body and the drill bit handle. An inner hole in an irregular shape is formed inside the drill bit handle, the shape of the top end of the drill bit body is the same as the shape of the inner hole, and the drill bit body and the drill bit handle are fixed to each other via high-strength glue. During mounting, the glue is smeared on the drill bit body or in the inner hole of the drill bit handle, the inner hole of the drill bit handle is a quadrilateral inner hole, and the top end of the drill bit body is a square handle.

### Fourth Embodiment

A drill bit provided with a high-torsion handle of the invention includes a drill bit body and the drill bit handle. An inner hole in an irregular shape is formed inside the drill bit handle, the shape of the top end of the drill bit body is the same that of the inner hole, and the drill bit body and the drill bit handle are fixed to each other via high-strength glue. During mounting, the glue is smeared on the drill bit body or in the inner hole of the drill bit handle, the inner hole of the drill bit handle is a hexagon inner hole, and the top end of the drill bit body is a hexagon handle.

### Fifth Embodiment

A drill bit provided with a high-torsion handle of the invention includes a drill bit body and the drill bit handle. An inner hole in an irregular shape is formed inside the drill bit handle, the shape of the top end of the drill bit body is the same as that of the inner hole, and the drill bit body and the drill bit handle are fixed to each other via high-strength glue. During mounting, the glue is smeared on the drill bit body or in the inner hole of the drill bit handle, the inner hole of the drill bit handle is a two-side cylindrical inner hole, and the top end of the drill bit body is a two-side polished handle.

### Sixth Embodiment

A drill bit provided a the high-torsion handle of the invention includes a drill bit body and the drill bit handle. An inner hole in an irregular shape is formed inside the drill bit handle, the shape of the top end of the drill bit body is the same as that of the inner hole, and the drill bit body and the drill bit handle are fixed to each other via high-strength glue. During mounting, the glue is smeared on the drill bit body or in the inner hole of the drill bit handle, the inner hole of the drill bit handle is a special two-side cylindrical inner hole, and the top end of the drill bit body is a special two-side unpolished handle which is matched with the drill bit handle.

### Seventh Embodiment

A drill bit provided a the high-torsion handle of the invention includes a drill bit body and the drill bit handle. An inner hole in an irregular shape is formed inside the drill bit handle, the shape of the top end of the drill bit body is the same as that of the inner hole, and the drill bit body and the drill bit handle are fixed to each other via high-strength glue. During mounting, the glue is smeared on the drill bit body or in the inner hole of the drill bit handle, the inner hole of the drill bit handle is a pentagonal inner hole, and the top end of the drill bit body is a pentagonal handle matched with the drill bit handle.

The invention overcomes defects existing for decades, radial run-out of products is small, and the following is a radial run-out comparison table of a stamped handle, a pin handle, a high-torsion handle and an integral handle:

| | 1/16 | 3/32 | ⅛ | 9/64 | 5/32 |
|---|---|---|---|---|---|
| Stamped handle | 0.80 | 0.68 | 0.70 | 0.76 | 0.74 |
| Pin handle | 0.24 | 0.25 | 0.26 | 0.26 | 0.25 |
| High-torsion | 0.10 | 0.10 | 0.10 | 0.11 | 0.12 |
| handle | | | | | |
| Integral handle | 0.13 | 0.12 | 0.13 | 0.13 | 0.13 |
| Improvement rate | 88% | 86% | 85% | 85% | 84% |

The following is a radial run-out deviation comparison table of the stamped handle, the pin handle, the high-torsion handle and the integral handle:

| | Stamped | Pin | Integral | High-torsion |
|---|---|---|---|---|
| | handle | handle | handle | handle |
| 1/16 | 1.09 | 0.3 | 0.17 | 0.16 |
| 3/32 | 1.09 | 0.22 | 0.17 | 0.16 |
| ⅛ | 1.09 | 0.22 | 0.17 | 0.15 |
| 9/64 | 1.34 | 0.22 | 0.18 | 0.15 |
| 5/32 | 1.09 | 0.18 | 0.18 | 0.16 |

The following is a torsion comparison table of the stamped handle, the pin handle and the high-torsion handle:

| | 1/16 | 3/32 | ⅛ | 9/64 | 5/32 |
|---|---|---|---|---|---|
| Stamped handle | 0.59 | 1.62 | 3.49 | 4.06 | 5.56 |
| Pin handle | 1.08 | 1.83 | 3.77 | 4.56 | 5.81 |
| High-torsion | 0.98 | 3.78 | 5.80 | 6.94 | 7.64 |
| handle | | | | | |
| Improvement rate | 66% | 134% | 66% | 71% | 37% |

The following is a torsion deviation comparison table of the stamped handle, the pin handle and the high-torsion handle

| | Stamped | Pin | High-torsion |
|---|---|---|---|
| | handle | handle | handle |
| 1/16 | 0.81 | 0.3 | 0.15 |
| 3/32 | 1 | 0.7 | 0.5 |
| ⅛ | 0.9 | 0.7 | 0.5 |
| 9/64 | 1.1 | 1 | 0.7 |
| 5/32 | 2.1 | 0.7 | 0.6 |

It can be learnt from the above comparison tables that the screwing tool provided with a high-torsion handle is high in torsion and small in radial run-out, and the effect of the high-torsion handle is basically consistent with the effect of the integral handle.

What is claimed is:

1. A screwing tool provided with a high-torsion handle, comprising:
a screwing tool body; and
a screwing tool handle, wherein a blind hole in an irregular shape is formed inside the screwing tool handle, a shape of a top end of the screwing tool body is the same as that of the blind hole, and the screwing tool body and the screwing tool handle are fixed to each other via glue.

2. The screwing tool with a high-torsion handle according to claim 1, wherein the bind hole is machined through the following steps:
(1) a hole is formed, an optimal angle between a workpiece and the ground is 90 degrees, a wavelength of an adopted laser machine is 1070-1080 nm, a degree of spatial freedom is six axes, an infrared light is used for aiming and positioning, a water cooling method is adopted, and a power of the laser machine is 5000 W; the blind hole with a diameter being 1.0 mm is firstly formed in the workpiece through a high-power CO laser light, a depth of the blind hole is measured through an infrared sensor, and the infrared sensor and the laser machine are both connected with a controller; after a laser drilling depth reaches a depth preset by the controller, the infrared light timely transmits a measured signal to the controller, and the controller controls the laser machine to stop operating;
(2) the blind hole in step (1) is burn-melted through a high-power laser machine, so that a dimensional precision of the blind hole reaches negative 0.2-0.3 mm, and a laser power reaches 3500 W;
(3) the shape of the blind hole is accurately machined through a laser device with the power being 2500 W, and a final machining precision is positive 0.1-0.15 MM.

3. The screwing tool provided with a high-torsion handle according to claim 1, wherein the blind hole is a semi-cylindrical inner hole, a triangular inner hole, a quadrilateral inner hole, a hexagonal inner hole, an octagonal inner hole, or a decagonal inner hole.

4. The screwing tool provided with a high-torsion handle according to claim 1, wherein the screwing tool is a drill bit, a sleeve or a screwdriver.

5. The screwing tool provided with a high-torsion handle according to claim 1, wherein a gap between the screwing tool body and the screwing tool handle is between 0.1 mm and 0.2 mm.

6. The screwing tool provided with a high-torsion handle according to claim 2, wherein the blind hole is a semi-cylindrical inner hole, a triangular inner hole, a quadrilateral inner hole, a hexagonal inner hole, an octagonal inner hole, or a decagonal inner hole.
